(19) United States
(12) Patent Application Publication
(10) Pub. No.: US 2018/0133589 A1
(43) Pub. Date: May 17, 2018

(54) EXERCISE GAME PIECE, KIT, AND METHODS

(71) Applicant: The Prophet Corporation, Owatonna, MN (US)

(72) Inventors: Christopher Lee Tuma, Mantorville, MN (US); Alison Marie Harguth, Owatonna, MN (US); Amber Lee Orenstein, Prior Lake, MN (US)

(21) Appl. No.: 15/352,004

(22) Filed: Nov. 15, 2016

(51) Int. Cl. A63F 9/00; A63B 26/00; A63F 9/26; A63B 67/06; G09B 19/00

(52) U.S. Cl. CPC A63F 9/00; A63B 26/003; G09B 19/003; A63B 67/06; A63F 9/26

(57) ABSTRACT

An exercise game piece includes a body with opposite base ends shaped to permit the game piece to stand. An intermediate section divides the body between a first section and a second section. The intermediate section is smaller in dimension than each of the opposite base ends. Indicia distinguishes the first section from the second section. The game piece can be used as part of a kit and to play a variety of games.

### TECHNICAL FIELD

This disclosure relates to a game piece that can be used for exercise or athletic training.

### BACKGROUND

Physical education class for children can be used to promote exercise, dexterity, and balance. New and different equipment to provide a variety of games and exercises to promote the physical health of people, including children, is desirable.

### SUMMARY

An exercise game piece is provided to improve the prior art.

In one aspect, an exercise game piece includes a body having first and second opposite ends and an intermediate section between the first and second ends. The body has a longitudinal axis extending through the body and through each of the first and second ends. The intermediate section divides the body into a first section having the first end and a second section having the second end. The first end defines a first base, and the second end defines a second base. The first base is shaped to permit the game piece to stand thereon. The second base is shaped to permit the game piece to stand thereon. The first end and the second end have a greatest dimension there across. The intermediate section has a greatest dimension across a transverse plane passing therethrough perpendicular to the longitudinal axis. The greatest dimension of the intermediate section is no greater than 90% of the greatest dimension of the first end and the greatest dimension of the second end. Indicia distinguishes the first section and the second section from each other.

In some aspects, the body has a length between the first end and second end of at least 4 inches and not greater than 15 inches.

The greatest dimension of the first end can be no more than 8 inches, and the greatest dimension of the second end can be no more than 8 inches.

The greatest dimension of the intermediate section can be no greater than 30-80% of the greatest dimension of the first end and the greatest dimension of the second end.

In some aspects, the greatest dimension of the intermediate section is no greater than 50-70% of the greatest dimension of the first end and greatest dimension of the second end.

In some embodiments, the intermediate section is located between 30-70% of a length of the body from one of the first end or second end.

In one or more arrangements, the intermediate section is centered between the first end and second end.

In some aspects, the first base and second base is each free of outer projections.

The first base and second base may each have a planar contact surface that is perpendicular to the longitudinal axis.

In some embodiments, at least one of the first base and second base can include one or more indented sections.

In some implementations, the greatest dimension of the first end and the greatest dimension of the second end are equal.

In some arrangements, the first base and second base have a same shape.

In example embodiments, the greatest dimension of the first end and of the second end is 3.5-5 inches; the greatest dimension of the intermediate section is 1.5-3 inches; and the body has a length between the first end and second end of 7-10 inches.

In some examples, the body is a single-molded plastic piece.

In one or more arrangements, the body has a weight of less than 5 pounds.

In one or more arrangements, the body has a weight of 0.25-2 pounds.

In one or more arrangements, the body has a weight of under 1 pound.

The indicia can include a visual distinction between the first section and the second section.

In example arrangements, the first section and second section are visually distinct from each other by being at least 2 different colors on any portion of the first section and the second section.

In an example arrangement, the first section is a first solid color, extending and including the first end to the intermediate section; and the second section is a second solid color, including and extending from the second end to the intermediate section.

In example arrangements, the first end has a shape of a polygon, and the second end has a shape of a polygon.

In example arrangements, the first end has a shape of a hexagon, and the second end has a shape of a hexagon.

In example arrangements, at least one of the first end or second end has a round shape.

In one or more arrangements, at least one of the first end and second end has an oval shape.

In one or more arrangements, at least the first end or second end has a triangle shape.

In one or more arrangements, the first end or second end has one of a diamond shape, rectangular shape, pentagon shape, or octagon shape.

In one or more arrangements, at least one of the first end or second end has opposite parallel sides jointed by rounded end sections.

In another aspect, a kit is provided. The kit includes plurality of exercise game pieces as variously characterized above.

The kit may also include a storage case or net.

The kit may include a number of exercise game pieces that are divisible by the number 2.

In another aspect, a method of playing a game is provided. The method includes providing a plurality of exercise game pieces as variously characterized above, and placing each of the game pieces on one of the first base or second base.

The method may further include playing the game by turning over at least one of the game pieces to rest on the opposite base from the initial orientation.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only and are not restrictive of the claimed invention.

### BRIEF DESCRIPTION OF THE DRAWINGS

FIG. 1 is a perspective view of one embodiment of an exercise game piece, constructed in accordance with principles of this disclosure;

FIG. 2 is a front view of the exercise game piece of FIG. 1;

FIG. 3 is a cross-sectional view of the exercise game piece of FIG. 1, the cross-section being taken along the line 3-3 of FIG. 2;

FIG. 4 is a bottom plan view of the exercise game piece of FIG. 1;

FIG. 5 is a cross-sectional view of the exercise game piece of FIG. 1, the cross section being taken along the line 5-5 of FIG. 2;

FIG. 6 is a fragmented cross sectional view, similar to the view of FIG. 3, but showing only an end portion and depicting an alternate embodiment;

FIG. 7 is a schematic top plan view of an alternate arrangement;

FIG. 8 is a schematic top plan view of an alternate arrangement;

FIG. 9 is a schematic top plan view of an alternate arrangement;

FIG. 10 is a schematic top plan view of an alternate arrangement;

FIG. 11 is a schematic top plan view of an alternate arrangement;

FIG. 12 is a schematic top plan view of an alternate arrangement; and

FIG. 13 is a schematic top plan view of an alternate arrangement.

### DETAILED DESCRIPTION

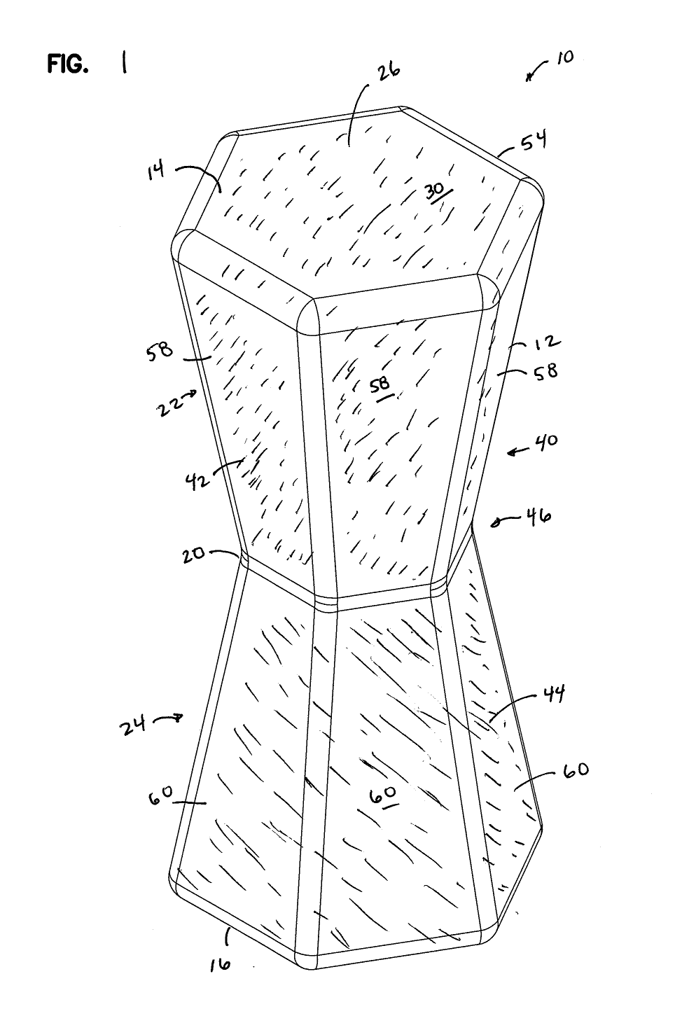

An example embodiment of an exercise game piece is shown in FIG. 1 at 10. The game piece 10 can be used to promote physical fitness, as well as improve dexterity and balance. A variety of methods of use and games can be played with the game piece 10 as is described further below.

The game piece 10 includes a body 12. The body 12 can be made from a variety of materials. In some embodiments, it is convenient to have the body be molded from a polymeric material. For example, it can be convenient to have the body 12 be molded as a single body made from plastic, such as vinyl. In one example, the body 12 is made from an injection molded process, such that the body 12 is one continuous piece of material. In other embodiments, the body 12 can be made of other materials, using other methods, and may include two or more parts fastened or otherwise connected together.

The body 12 has a first end 14 and an opposite second end 16. The body 12 has a longitudinal axis 18 (FIG. 2) that extends through the body 12 and through each of the first end 14 and second end 16.

The body 12 further includes an intermediate section 20. The intermediate section 20 is a section or region along the body 12 that is at some point between the first end 14 and second end 16. The intermediate section 20 divides the body 12 into a first section 22 and a second section 24. The first section 22 includes the first end 14, while the second section 24 includes the second end 16. In general, the first section 22 includes the entire portion of the body 12 starting from the intermediate section 20 through and including the first section 22. The second section 24 includes the region starting at the intermediate section 20 and extending through and to the second end 16.

The intermediate section 20 can be located on the body 12 at any location spaced from each of the first end 14 and second end 16. In general, intermediate section 20 is located along the body 12 between 30-70% of a length of the body 12 from one of the first end 14 or second end 16. For example, in many embodiments, the intermediate section 20 is located somewhere between 40-60% of a length of the body 12 from the first end 14 or second end 16. In the particular arrangement shown, the intermediate section 20 is located at about 50% of the length of the body 12 from the first end 14 and second end 16. In other words, the intermediate section 20, in the embodiment shown, is centered along the body 12 between the first end 14 and second end 16.

The first end 14 defines a first base 26. The second end 16 defines a second base 28. Each of the first base 6 and second base 28 are each shaped to permit the game piece 10 to stand thereon. In other words, each of the first base 26 and second base 28 are shaped so that when the game piece 10 is oriented or placed on a surface, such as a gym floor, the game piece 10 will be stable and steady and remain as oriented resting on either the first base 26 or second base 28, unless knocked over with sufficient force to cause the game piece 10 to fall on its side. Under normal conditions, once the game piece 10 is placed on either the first base 26 or second base 28, the game piece 10 will remain in that orientation.

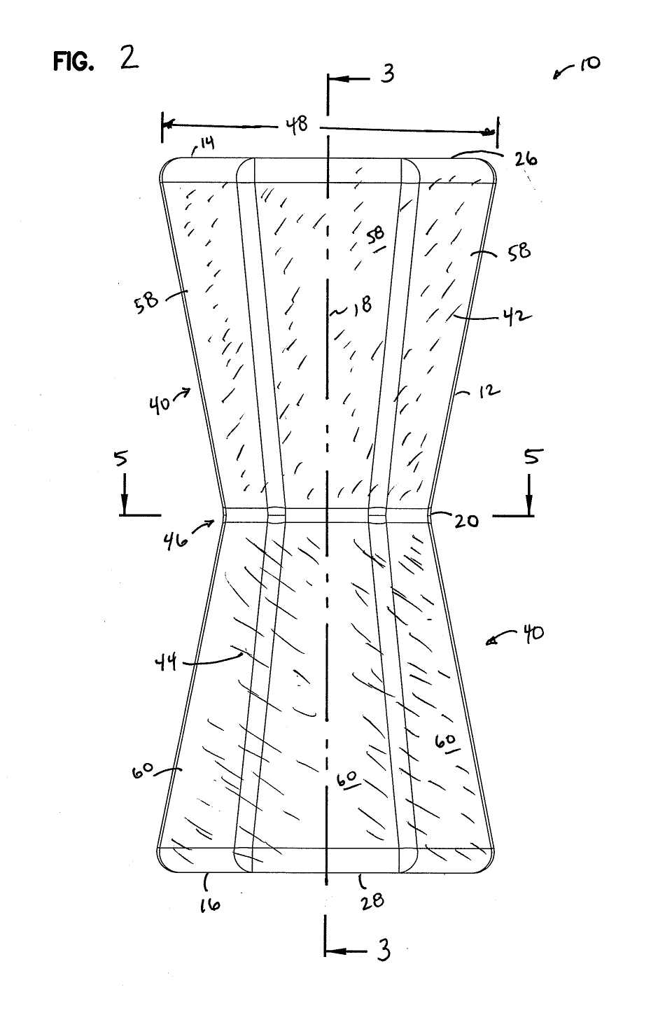

In general, the first base 26 and second base 28 will be free of outer projections or any other structure that would introduce instability. The first base 26 and second base 28 can each have slightly domed contact surface 30, 32 (see FIG. 3). Alternatively, the contact surface 30, 32 can be planar, which will be in a plane that is perpendicular to the longitudinal axis 18.

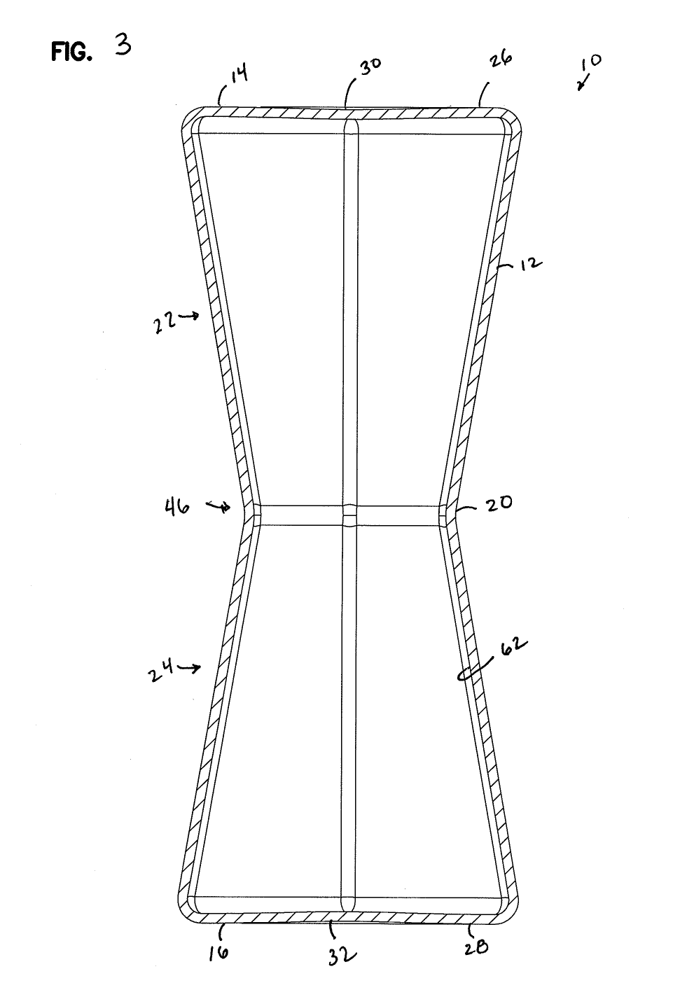

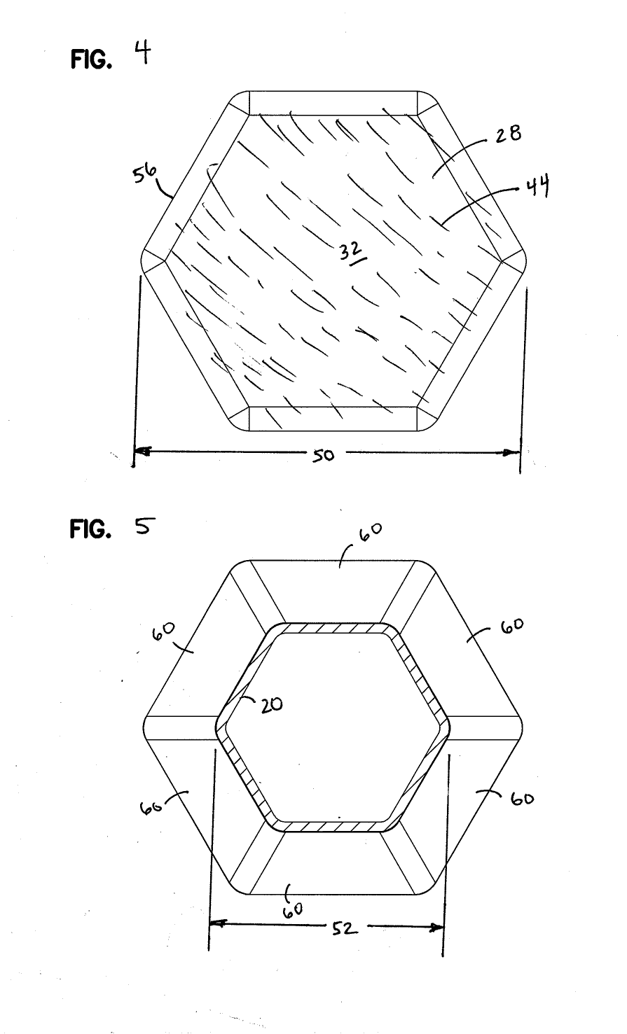

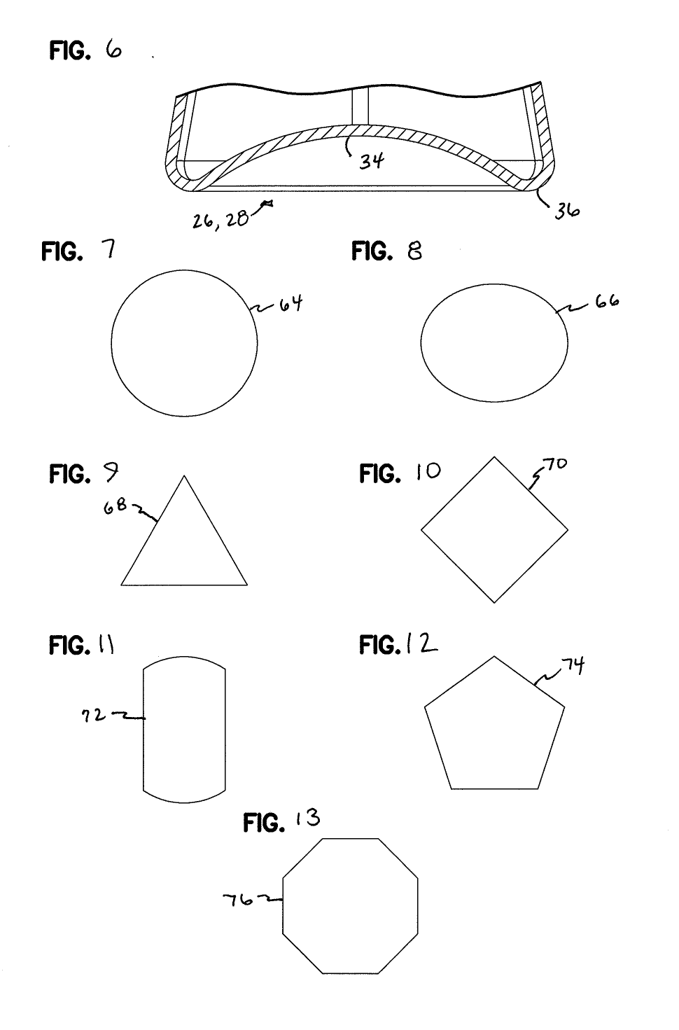

The first base 26 and second base 28 can have other shapes, as well, as long as they create stable surfaces to keep the game piece 10 oriented on either the first end 14 and second end 16. FIG. 6 illustrates an alternate embodiment, in which at least one of the first base 26 or second base 28, or both, includes one or more indented sections 34. In FIG. 6, a single indented section 34 is shown as a generally concave surface. The first base 26 or second base 28 would be stable because the ends 14, 16 would rest along the outer perimeter rim 36. Many other embodiments are possible.

In accordance with principles of this disclosure, the game piece 10 includes indicia to distinguish the first section 22 and the second section 24 apart from each other. In FIGS. 1 and 2, the indicia are shown generally at reference numeral 40. The indicia 40 can be any characteristic that a human can detect to allow them to distinguish between the first section 22 and second section 24. The indicia may be tactile (such as soft vs. prickly or smooth vs. bumpy), visual, or both. In this embodiment, the indicia 40 is a visual indicia such that a person can tell the difference between the first section 22 and second section 24 by seeing it.

The indicia 40 can be located on any portion of one or both of the first section 22 and second section 24. For example, the indicia 40 could include markings isolated only to one of the first base 26, or the second base 28, or it could be on both the first base 26 and second base 28. In addition, visual indicia 40 could include markings or patterns located on only a portion or all of at least one of the first section 22 and second section 24. If there are markings or patterns on both the first section 22 and second section 24, the markings or patterns would be different such that a person could visually distinguish between the first section 22 and second section 24.

While many different indicia 40 are possible, in the embodiments shown, the first section 22 is a first solid color that includes the first end 14 and the body 12 extending to the intermediate section 20. The second section 24 is a second solid color including the second end 16 and the body 12 until the intermediate section 20. For example, the first color 42 can be yellow, while the second color 44 is blue. As mentioned previously, the indicia 40, including the colors 42, 44 can be limited to only a portion of the first section 22 and second section 24, such as being only on the first end 14 and second end 16. Many variations are possible.

In general, the intermediate section 20 will form a waist or neck 46 along the body 12 of reduced dimension compared to the first and second ends 14, 16. The waist or neck 46 allows for convenient grasping and handling of the game piece 10. In general, the waist or neck 46 is sized to allow for grasping and handling by at least a child sized hand. If the waist or neck 46 is too large (e.g., the same size or greater than the size of the first and second ends 14, 16), it could be difficult to grasp by hand, and/or it may be less stable. If the waist or neck 46 is too small, it may be fragile or also difficult to grasp by hand. The proportions shown in FIGS. 1-3 can vary from as shown, but the proportions shown are eye-catching and attractive.

For example, the first end 14 has a greatest dimension 48 (FIG. 1) there across. Similarly, the second end 16 has a greatest dimension 50 (FIG. 4) there across. The intermediate section 20 has a greatest dimension 52 (FIG. 5) across a transverse plane that passes there through and perpendicular to the longitudinal axis 18. The greatest dimension 52 of the intermediate section 20 is no greater than 90% of the greatest dimension 48 of the first end 14 and the greatest dimension 50 of the second end 16.

In preferred implementations, the greatest dimension 52 of the intermediate section 20 is no greater than 30-80% of the greatest dimension 48 of the first end 14 and of the greatest dimension 50 of the second end 16. Indeed, in many preferred arrangements, the greatest dimension 52 of the intermediate section 20 is no greater than 50-70% of the greatest dimension 48 of the first end 14 and of the greatest dimension 50 of the second end 16. For example, the greatest dimension 52 of the intermediate section 20 can be about 60-65% of the greatest dimension 48 of the first end 14 and of the greatest dimension 50 of the second end 16.

The first end 14 and second end 16 can have different shapes, or they can have the same shape. In some games of balance or dexterity, it may be advantageous to have the first end 14 and second end 16 shaped differently. In the example shown, first end 14 and second end 16 have first and second bases 26, 28 that have the same shape. Also, the greatest dimension 48 of the first end 14 and the greatest dimension 50 of the second end 16 are equal in the example embodiment shown. In other embodiments, the greatest dimensions 48, 50 can be different.

In the example shown, the first end 14 has a shape of a polygon, and the second end 16 has a shape of a polygon. In the particular arrangement shown, the polygon shape of the first end 14 is the same as the polygon shape of the second end 16. Many embodiments are possible, and in the one shown, the first end 14 and second end 16 have the shape of hexagon 54 (FIG. 1), 56 (FIG. 4).

When the ends 14, 16 have a polygon shape, the body 12 has a plurality of facets or faces 58, 60, extending between the first end 14, second end 16, and the intermediate section 20. For example, in FIG. 1, there are six faces 58 extending between the first end 14 and the intermediate section 20. Similarly, there are 6 faces 60 extending between the second end 16 and the intermediate section 20. Of course, the body 12 could be made to have a different shape, even though the ends 14, 16 are polygon shaped.

FIG. 5 illustrates the shape of the intermediate section 20 as having the same polygon shape as each of the first ends 14, 16. Other arrangements are possible.

The first and second ends 14, 16 need not be polygon shaped, and if polygon shaped, they need not be hexagon shaped. FIGS. 7-13 illustrate a variety of variations for the first end 14 and second end 16. In many cases, both the first end 14 and second end 16 will have the same shape, but as mentioned above, it is possible to have differently shaped first and second ends 14, 16.

For example, the first end 14 and/or second end 16 can be circle-shaped 64 (FIG. 7); oval-shaped 66 (FIG. 8); triangle-shaped 68 (FIG. 9); diamond or square-shaped 70 (FIG. 10); opposite parallel sides with opposite rounded ends-shaped 72 (FIG. 11); pentagon-shaped 74 (FIG. 12); and octagon-shaped 76 (FIG. 13). The polygon can be any n-sided polygon. The shapes of the first and second ends 14, 16 can be selected based on what is eye-catching and attractive. It should be understood that many other shapes for the first and second ends 14, 16 are possible and contemplated herein.

The game piece 10 can be part of an overall kit. The kit can include a plurality of exercise game pieces 10. In addition, the kit can include a storage bag for conveniently holding the plurality of game pieces 10. In many cases, the kit will include an even number of game pieces 10, which is helpful for dividing the number of game pieces 10 into teams of two.

The games pieces 10 can be used to play a variety of games. In many cases, the game will include providing the game pieces 10 and placing each of the game pieces 10 to rest on one of the first base 26 or second base 28. The game can include turning over one or more of the game pieces 10 to rest on the opposite base from the initial orientation.

For example, one game can include placing the game pieces 10 on a flat surface playing area such that half of the games pieces 10 are resting on the first base 26, while the other half of the game pieces 10 are resting on the second base 28. The participants are divided into two teams, and at the signal, the players run from game piece 10 to game piece 10 flipping the game pieces 10 so that their team's designated color is oriented upwardly or is on the top. At the end signal, the players freeze in their location. Points are awarded by the color at the upper end of the game piece 10. Game pieces 10 that are lying on their sides do not count for points. Variations can include the players needing to skip, hop, or jump to each game piece 10.

Another game that can be played with the game piece 10 includes a relay. The playing area is divided into six lanes, and the players are divided into six equal teams. Four game pieces 10 are placed in a row in each lane. The teams line up behind a starting point, and at the signal, the first player from each team runs to the end of the lane and flips the game piece 10 to the opposite end. The player then returns to the starting point, and the second player runs to flip the next game piece 10. The play continues until all four game pieces 10 have been flipped, and all players have returned to the starting point.

Another game that can be played with the game pieces 10 includes target practice, in which each team receives a plurality of game pieces 10, such as six and some foam balls. The game pieces 10 are stacked into a pyramid. The players take turns throwing foam balls at the pyramid of game pieces 10 attempting to knock the whole pyramid over in one throw.

The games pieces 10 can also be used in agility activities. For example, teams of two partners can be set up, with each team receiving two game pieces 10. Each game piece 10 is set up on either the first base 26 or second base 28. The objective is to flip your partner's game piece 10 before your partner flips your game piece 10.

The game pieces 10 can also be used in shuffling exercises, including shuffling around two game pieces 10 in a FIG. 8 pattern. The game pieces 10 can also be set up with four of them, with players running around the game pieces 10 in a cloverleaf pattern. Or, the game pieces 10 can be placed in a row with players weaving between them. If any of the game pieces 10 are toppled over, the player must repeat the drill.

The game piece 10 will generally be made of a size, weight, and material so that it is not dangerous if a person throws one. As mentioned previously, it is convenient to make the game piece 10 from plastic, such as vinyl. The body 12 will generally have a weight of less than 5 lbs., usually less than 2 lbs., and typically 0.25-2 lbs. As can be seen in FIG. 3, typically the game piece 10 is hollow with molded wall of the body surrounding an open interior volume 62. It is contemplated that in other embodiments, the interior volume 62 could hold filler material if it is desired to have a heavier game piece 10.

The body 12 will have a length between the first end 14 and second end 16 of at least 4 inches and not greater than 15 inches. For example, the body 12 will have a length between the first end 14 and second end 16 of 7-10 inches, for example, about 8-9 inches.

The greatest dimension of the first end 14 will typically be no more than 8 inches. Similarly, the greatest dimension of the second end 16 is typically no more than 8 inches. In many instances, the greatest dimension of the first end 14 is 3.5-5 inches, for example, about 4 inches. Similarly, the greatest dimension of the second end 16 is about 3.5-5 inches, for example, about 4 inches.

The greatest dimension of the intermediate section 20 will be at least 1 inch and often not greater than 3.5 inches. In many instances, the greatest dimension of the intermediate section 20 is 1.5-3 inches, for example, about 2.5 inches.

The above represents example principles. Many embodiments can be made using these principles.

What is claimed is:

1. An exercise game piece comprising:
(a) a body having first and second opposite ends and an intermediate section between the first and second ends; the body having a longitudinal axis extending through the body and through each of the first and second ends;
(i) the intermediate section dividing the body into a first section having the first end, and a second section having the second end;
(b) the first end defining a first base, and the second end defining a second base;
(i) the first base being shaped to permit the game piece to stand thereon;
(ii) the second base being shaped to permit the game piece to stand thereon;
(c) the first end having a greatest dimension thereacross;
(d) the second end having a greatest dimension thereacross;
(e) the intermediate section having a greatest dimension across a transverse plane passing therethrough perpendicular to the longitudinal axis;
(i) the greatest dimension of the intermediate section being no greater than 90% of the greatest dimension of the first end and the greatest dimension of the second end; and
(f) indicia to distinguish the first section from the second section.

2. The exercise game piece of claim 1 wherein the body has a length between the first end and second end of at least 4 inches and not greater than 15 inches.

3. The exercise game piece of claim 2 wherein the greatest dimension of the first end is no more than 8 inches; and the greatest dimension of the second end is no more than 8 inches.

4. The exercise game piece of claim 1 wherein the greatest dimension of the intermediate section is no greater than 30-80% of the greatest dimension of the first end and the greatest dimension of the second end.

5. The exercise game piece of claim 1 wherein the greatest dimension of the intermediate section is no greater than 50-70% of the greatest dimension of the first end and the greatest dimension of the second end.

6. The exercise game piece of claim 1 wherein the intermediate section is located between 30-70% of a length of the body from one of the first end or second end.

7. The exercise game piece of claim 1 wherein the intermediate section is centered between the first and second ends.

8. The exercise game piece of claim 1 wherein the first base and second base is each free of outer projections.

9. The exercise game piece of claim 1 wherein the first base and second base each has a planar contact surface perpendicular to the longitudinal axis.

10. The exercise game piece of claim 1 wherein at least one of the first base and second base includes one or more indented sections.

11. The exercise game piece of claim 1 wherein the greatest dimension of the first end and the greatest dimension of the second end are equal.

12. The exercise game piece of claim 1 wherein the first base and the second base have a same shape.

13. The exercise game piece of claim 1 wherein:
(a) the greatest dimension of the first end is 3.5-5 inches;
(b) the greatest dimension of the second end is 3.5-5 inches;
(c) the greatest dimension of the intermediate section is 1.5-3 inches; and
(d) the body has a length between the first end and second end of 7-10 inches.

14. The exercise game piece of claim 1 wherein the body is a single-molded plastic piece.

15. The exercise game piece of claim 1 wherein the body has a weight of less than 5 lbs.

16. The exercise game piece of claim 1 wherein the body has a weight of 0.25-2 lbs.

17. The exercise game piece of claim 1 wherein the indicia includes a visual indicia.

18. The exercise game piece of claim 17 wherein the first section and second section are visually distinct from each other by being at least two different colors on any portion of the first section and second section.

19. The exercise game piece of claim 18 wherein:
(a) the first section is a first solid color including the first end to the intermediate section; and
(b) the second section is a second solid color including the second end to the intermediate section.

20. The exercise game piece of claim 1 wherein the first end has a shape of a polygon, and the second end has a shape of a polygon.

21. The exercise game piece of claim 20 wherein the first end has a shape of a hexagon, and the second end has a shape of a hexagon.

22. The exercise game piece of claim 1 wherein at least one of the first end and second end has an outer perimeter shape of one of a: circle; oval; triangle; diamond; pentagon; octagon; and opposite parallel sides with rounded ends.

23. A kit for an exercise game, the kit comprising:
(a) a plurality of exercise game pieces according to claim 1.

24. A method of playing a game; the method comprising:
(a) providing a plurality of exercise game pieces according to claim 1; and
(b) placing each of the game pieces on one of the first base or second base.

25. The method of claim 24 further including:
(a) playing the game by turning over at least one of the game pieces to rest on the opposite base from the initial orientation.
